(19) United States
(12) Patent Application Publication
(10) Pub. No.: US 2006/0130404 A1
(43) Pub. Date: Jun. 22, 2006

(54) Quick release for security bars system

(76) Inventor: Mitchell R. Lilly, Lexington, KY (US)

Correspondence Address: LITMAN LAW OFFICES, LTD, PO BOX 15035, CRYSTAL CITY STATION, ARLINGTON, VA, 22215, US

(21) Appl. No.: 11/103,529

(22) Filed: Apr. 12, 2005

Related U.S. Application Data
(60) Provisional application No. 60/632,963, filed on Dec. 6, 2004.

(51) Int. Cl. E05F 15/00; G08B 19/00; G08B 17/00; G08B 17/10

(52) U.S. Cl. 49/280; 340/521; 340/584; 340/632; 340/628

(57) ABSTRACT

The quick release for security bars system automatically unlocks the security bars fitted on the exterior of a building in response to a signal from a fire detection device. On any window or other opening fitted with hinged security bars, one or more quick release latching mechanisms are attached to the side of the bars opposite the hinges. The quick release latching mechanism has an electric solenoid wherein the plunger of the solenoid is fitted with a male portion that engages with a fixed female portion. When a fire detection device, such as a heat detector, smoke detector, or gas sensor, triggers an alarm, power to the solenoid is interrupted and the plunger of the solenoid extends and disengages the male portion from the female portion and therefore disengages the security bars.

### CROSS-REFERENCE TO RELATED APPLICATION

This application claims the benefit of U.S. Provisional Patent Application Ser. No. 60/632,963, filed Dec. 6, 2004.

### BACKGROUND OF THE INVENTION

1. Field of the Invention

The present invention relates to security bar systems, and particularly to a quick release system for the security bars on windows and doors in order to allow occupants of a dwelling to escape in the event of a fire.

2. Description of the Related Art

Many homes and businesses have security bars mounted on the exterior of the building over doors and windows to prevent unauthorized entry. Although security bars are effective against intruders to a building, they can be a safety hazard to occupants of the building trying to escape in the event of a fire or other emergency. This is particularly true of security bars that are permanently mounted over a door or window and cannot be opened. Security bars can also prevent fire fighters or other rescue personnel from gaining access to a building in times of emergency.

In addition to permanently mounted security bars, there are also security bar systems mounted on hinges that can be moved to an open position. Security bars that can be moved to an open position still present a safety hazard, since they are usually secured by a keyed lock. In the event of a fire or other emergency, an occupant may lack the necessary time to unlock the security bars, or the keys may be inaccessible. It is also not only windows with security bars that can present a safety hazard, but sometimes regular windows are equipped with locks that cannot be opened in an emergency situation. Although rescue personnel are equipped with tools for breaking a window, a building occupant may not have the time or wherewithal to exit through a locked window if panic is setting in.

Several devices have been proposed to address the problem of security bars preventing escape from a burning building. One solution is to have the lock on a set of security bars remotely controlled, usually by some sort of radio transmitter. Unfortunately the use of a transmitter and radio-controlled technology is expensive and involves many moving parts that are also subject to costly maintenance. Other methods and devices have been suggested to solve these problems.

Japanese Patent No. 3-180,680, published Aug. 6, 1991, shows an emergency unlocking device featuring a memory alloy that changes shape and releases the locking device when the atmospheric temperature reaches the transformation temperature. Japanese Patent No. 5-59,852, published Mar. 9, 1993, shows an electric lock system that automatically releases an electric lock at the time of a fire or earthquake by means of a control device and a signal conductor. A web page published on the World Wide Web at www.inventionconnection.com, at least as of Oct. 20, 2004, shows a mechanism for releasing the security bars on windows featuring a thermo-bulb that releases the security bars at elevated temperatures.

None of the above listed inventions, taken either singly or together, is thought to describe the present invention. Thus, a quick release for security bars system solving the aforementioned problems is desired.

### SUMMARY OF THE INVENTION

The quick release for security bars system automatically unlocks the security bars fitted on the exterior of a building in response to a signal from a fire detection device. On any window or other building opening fitted with hinged security bars, one or more quick release latching mechanisms are attached to the side of the bars opposite the hinges. The quick release latching mechanism has an electric solenoid. The plunger of the solenoid is fitted with a male portion that engages with a fixed female portion. When a fire detection device, such as a heat detector, smoke detector, or gas sensor, triggers an alarm, power to the solenoid is interrupted and the plunger of the solenoid extends and disengages the male portion from the female portion and therefore disengages the security bars.

Other features of the quick release for security bars system include a control panel and hard wiring between components of the system. The control panel permits a user to monitor which security bars are in a locked position and also allows the user to conduct monthly tests of the system. The quick release for security bars system is powered by a building's AC power supply or, alternatively, by a thirty-day 48-volt battery back up system. The quick release for security bars system could also be used on windows with sliding panes by attaching the quick release mechanism to the sill of a window and the frame of one of the panes of glass.

These and other features of the present invention will become readily apparent upon further review of the following specification and drawings.

### BRIEF DESCRIPTION OF THE DRAWINGS

FIG. 1 is an environmental, perspective view of a dwelling equipped with the quick release for security bars system according to the present invention.

FIG. 2A is a bottom view of the quick release system of the present invention when latched.

FIG. 2B is a bottom view of the quick release system of the present invention when unlatched.

FIG. 3 is a block diagram of the quick release system of the present invention.

FIG. 4A is an environmental perspective view of the quick release system of the present invention mounted on a window.

FIG. 4B is a detailed perspective view of the quick release system of the present invention mounted on a window.

FIG. 5 is a front view of the control panel of the quick release system of the present invention.

Similar reference characters denote corresponding features consistently throughout the attached drawings.

### DETAILED DESCRIPTION OF THE PREFERRED EMBODIMENTS

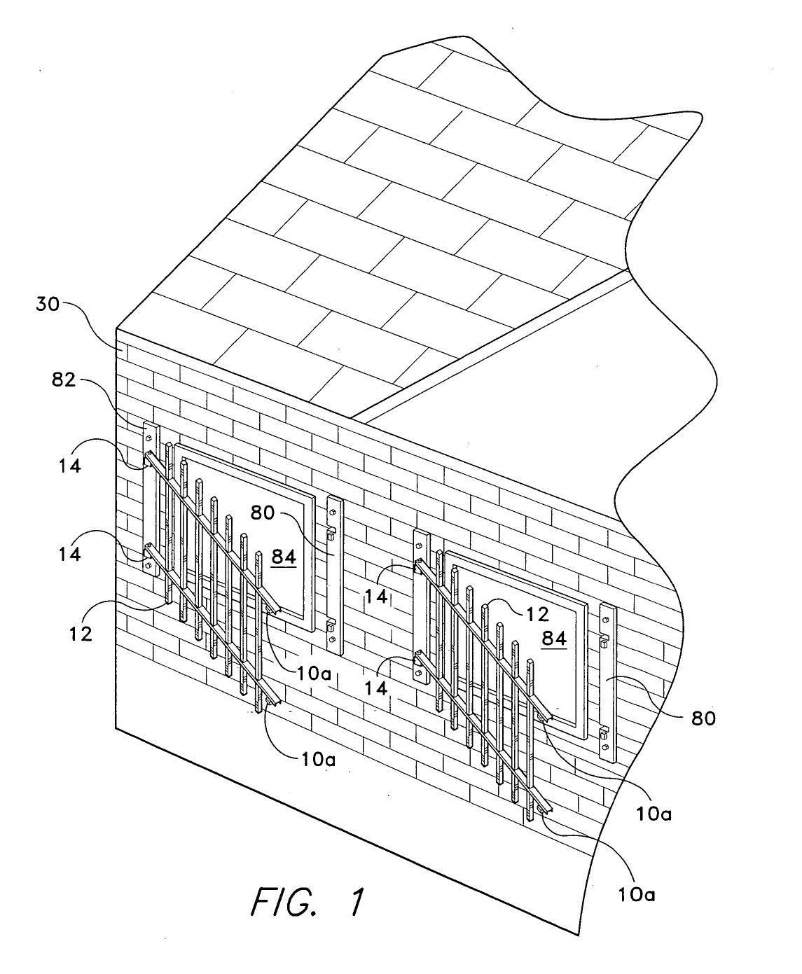

The present invention is a quick release for security bars system. FIG. 1 shows a building 30 with security bars 12 mounted on hinges 14 over a window 84. The quick release latching mechanism, shown generally as 10a, is attached to the security bars opposite to the hinges 14.

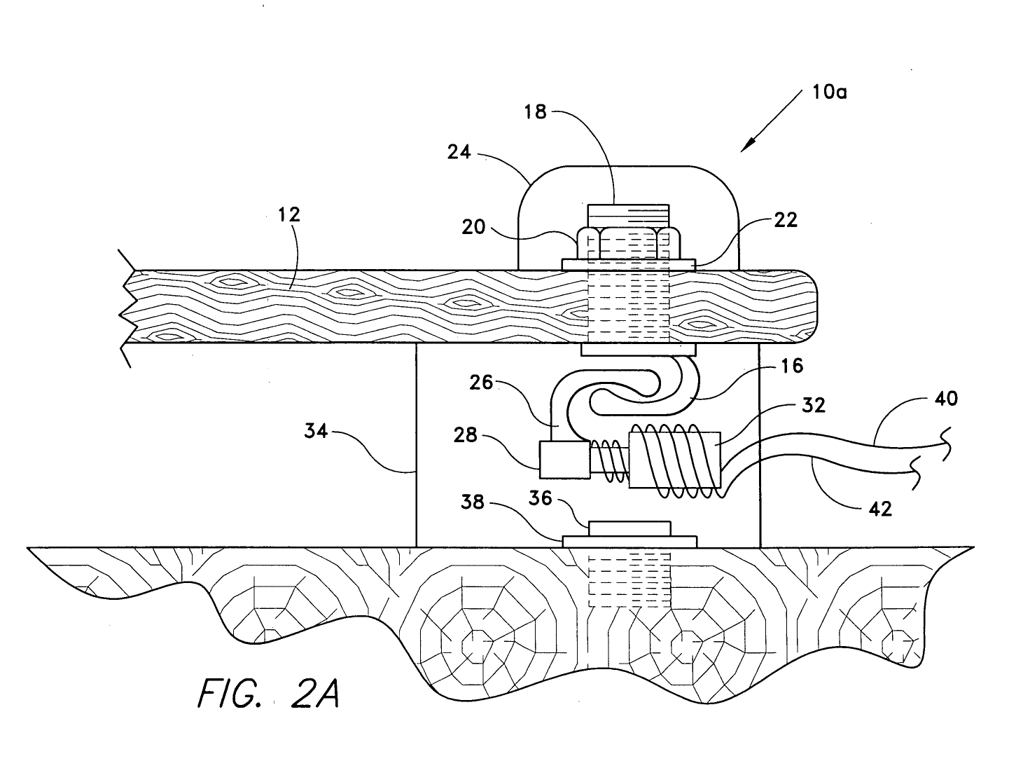

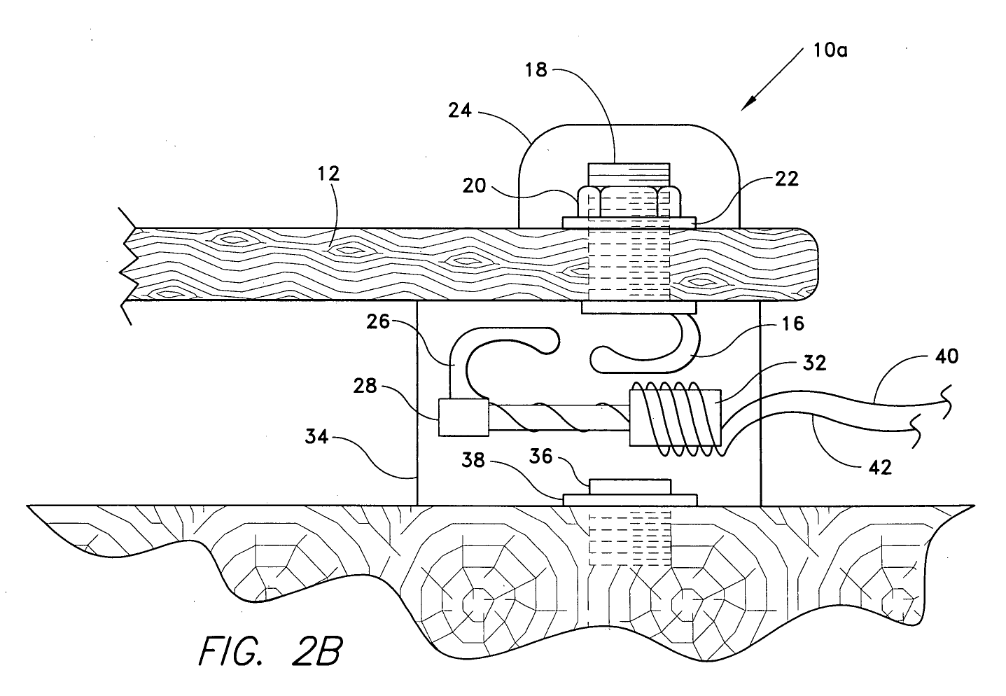

The quick release latching mechanism 10a is shown in detail in FIG. 2A. The female portion 16 of the quick release latching mechanism 10a is rigidly mounted to the security bars 12 by use of a bolt 18 that goes through the security bar 12 and is held in place by a nut 20 and a washer 22. A cover 24 is placed over the bolt 18, nut 20 and washer 22 to prevent tampering and corrosion from the weather. The male portion 26 of the quick release latching mechanism 10a is attached to the exterior of the building 30 in alignment with the female portion 16 of the quick release latching mechanism 10a. Alternatively, the male portion may be attached to a mounting strip 80 similar to the brackets 82 that the hinges 14 are mounted to. The male portion 26 is attached to the plunger 28 on a solenoid 32 that is located inside a housing 34. The housing 34, which contains the male portion 26 and solenoid 32, is attached to the exterior of a building using low-profile bolt 36 and washer 38.

FIG. 2A shows the solenoid 32 energized through leads 40 and 42. When energized, the plunger 28 remains inside the solenoid 32, thereby keeping the male portion 26 of the quick release latching mechanism 10a engaged with the female portion 16. When the solenoid 32 is de-energized, as shown in FIG. 2B, the plunger 28 extends outward and disengages the male portion 26 from the female portion 16, thereby allowing the security bars 12 to swing free and allow entrance or egress through otherwise inaccessible windows.

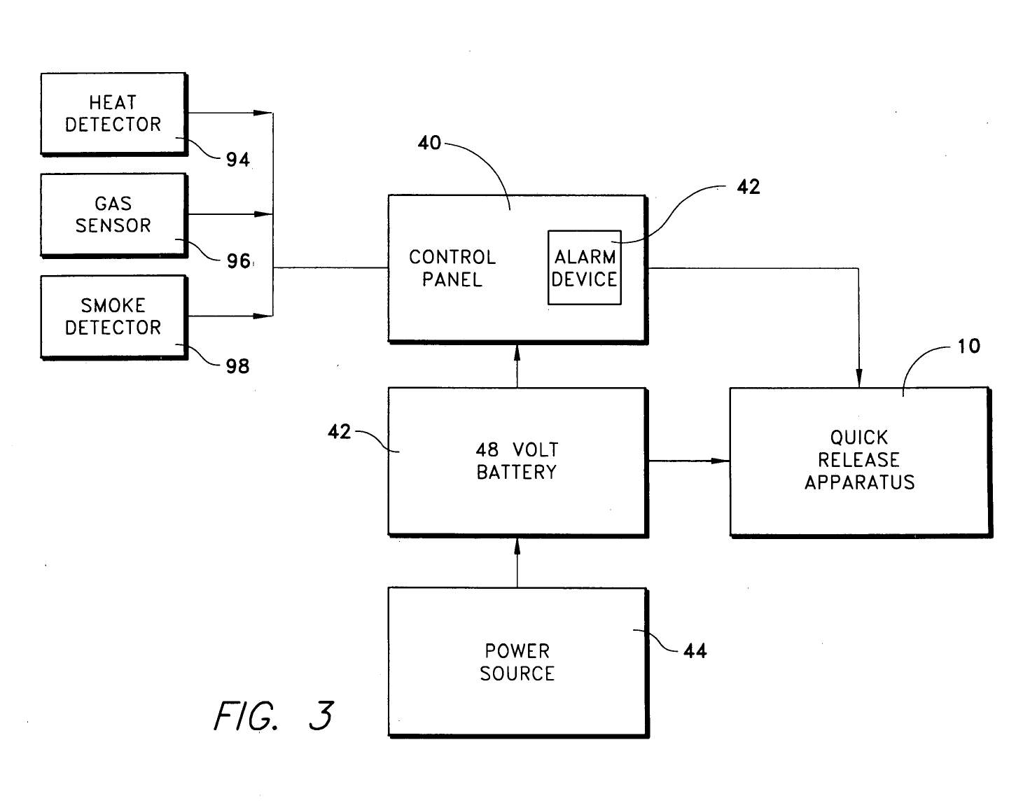

The components of the quick release system are shown in the block diagram in FIG. 3. Because the quick release system for security bars is intended to be used in emergency situations, it is connected to the fire protection systems of a building. Fire detection sensors, such as a heat detector 34, a gas sensor 36 and a smoke detector 38, are connected to a control panel 40. Control panel 40 has an alarm device 42 that signals occupants of a building in the event of a positive input signal from one of the fire detection sensors. The control panel 40 also houses circuitry configured to automatically disconnect power to the solenoid 32 when the fire detection sensor is triggered, thereby de-energizing the solenoid 32, causing the plunger 28 to extend and disengaging the male portion 26 from the female portion 16. Control panel 40 is powered by a 48-volt battery 42. The 48-volt battery 42 also provides power to the quick release latching mechanisms 10a positioned on security bars on a building. In this manner the system will not be affected by a loss of power to a building. The 48-volt battery is rechargeable through a power source 44. In one embodiment, the power source 44 provides a trickle charge to the 48-volt battery 42 so that the battery 42 is constantly fully charged. The quick release for security bars system is hard wired between components in order to reduce reliance on sometimes undependable radio transmitters. Hard wiring between components also reduces the cost of the quick release system for security bars as compared to other products for remotely operated security bar systems.

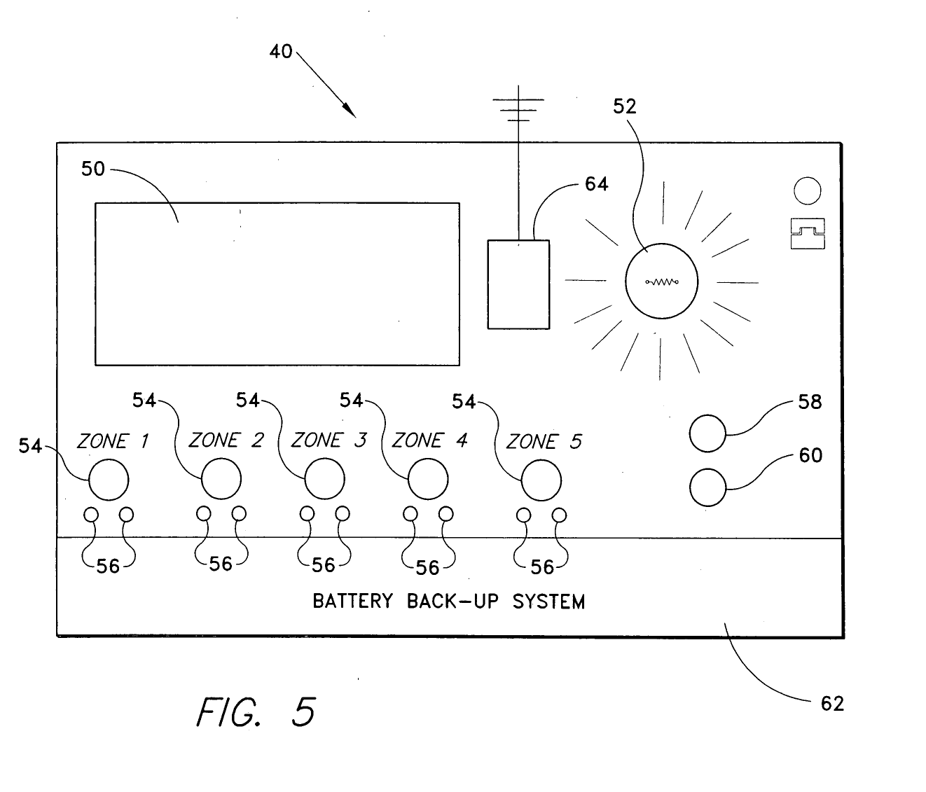

FIG. 5 shows an example of a control panel 40 for the quick release for security bars system. The control panel 40 is located in a central, generally accessible area of a building. A display screen 50 shows the time and date and other information, such as the charge of the battery system. The control panel also has an alarm device 52 that activates when it received a signal from the fire protection devices. Another feature of the control panel is test buttons 54 for the various zones of a building that have the quick release latching mechanism 10a installed. For example, Zone 1 may be a bedroom, Zone 2 may be the kitchen, with continually higher numbered zones designating other rooms in a building. By depressing the test button 54 for Zone 1 the quick release latching mechanism on the security bars in the bedroom is deactivated and the security bars swing free. LED's 56 below the test buttons 54 tell a user which quick release latching mechanisms are currently engaged. A reset button 58 and a monthly test button 60 activate all the quick release latching mechanisms 10a for a building. As a secondary backup, the control panel 50 is also equipped with a battery back-up 62 in the control panel and a transformer 64 to receive power from a conventional 115- or 120-volt power source. The control panel may also be equipped with circuitry connected to phone lines so that a signal may be sent to emergency response services in the event of the alarm device 52 being activated.

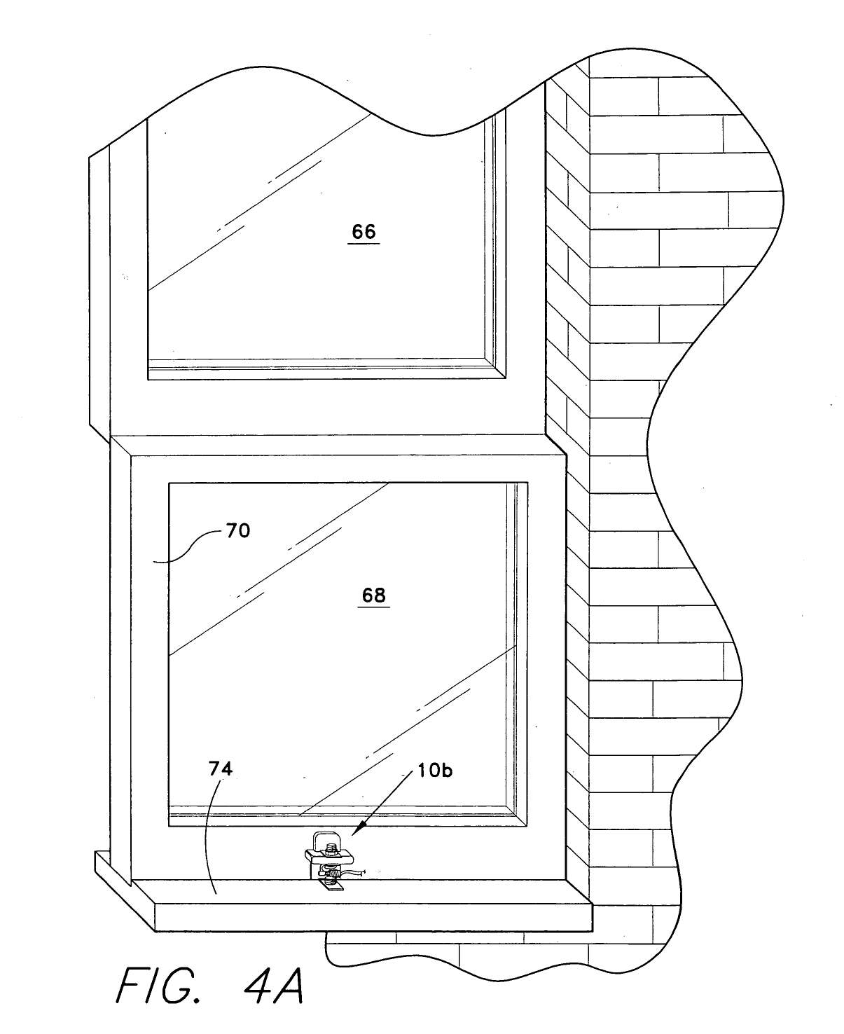

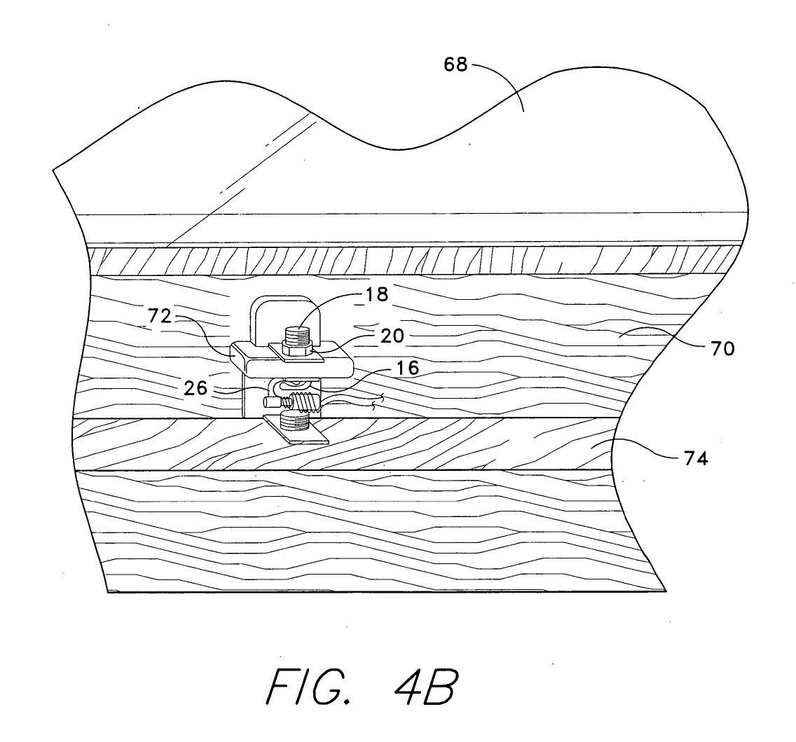

It is contemplated that the quick release system is not limited to releasing security bars 12. FIG. 4A shows an embodiment of the quick release latching mechanism 10b mounted to a window with an immovable upper pane 66 and a lower sliding pane 68. FIG. 4B shows a close up view of the quick release latching mechanism 10b. The female portion 16 of the quick release latching mechanism 10b is mounted to the frame 70 of the lower sliding pane 68 by use of a bolt 18 that goes through a shelf 72 attached to the frame 70 and is held in place by a nut 20. The male portion 26 of the quick release latching mechanism 10b is attached to the sill 74 of the window in alignment with the female portion 16 of the quick release latching mechanism 10b.

It is to be understood that the present invention is not limited to the embodiments described above, but encompasses any and all embodiments within the scope of the following claims.

I claim:

1. A quick release system, comprising:
an electric solenoid with an extendable plunger, the solenoid being adapted for attachment to a frame of a building opening;
a male engagement member attached to the extendable plunger of the solenoid;
a female engagement member adapted for attachment to a building opening closure member in alignment with the male engagement member, the male and female engagement members forming a quick release latching mechanism;
at least one fire detection device selected from the group consisting of a gas sensor, a heat detector, and a smoke detector;
an alarm device having a horn activated when receiving a positive signal from the fire detection device; and
a control panel having means for interrupting power to the quick release latching mechanism after receiving a positive signal from the fire protection device to extend the plunger and disengage the male and female members.

2. The quick release system according to claim 1, wherein the electric solenoid, the fire detection device, and the control panel are hardwired together in series.

3. The quick release system according to claim 1, further comprising a battery back-up system connected to the control panel.

4. The quick release system according to claim 1, further comprising a power source having a battery and a means for applying a trickle charge to keep the battery fully charged.

5. The quick release system according to claim 4, wherein the battery is a 48-volt battery.

6. The quick release system according to claim 1, further comprising a housing enclosing the electric solenoid.

7. The quick release system according to claim 1, wherein the at least one fire protection device comprises two fire protection devices.

8. The quick release system according to claim 1, wherein the at least one fire protection device comprises three fire protection devices.

9. The quick release system according to claim 1, wherein said solenoid is adapted for attachment to a window frame of the building and said female engagement member is adapted for attachment to security bars selectively closable over the opening defined by the window frame.

10. The quick release system according to claim 1, wherein aid solenoid is adapted for attachment to a window frame of the building and said female engagement member is adapted for attachment to a frame of a sliding window pane.

11. The quick release system according to claim 1, further comprising a nut, a bolt and at least one washer adapted for attaching said female engagement member to the building opening closure member.
